(19) United States
(12) Patent Application Publication
(10) Pub. No.: US 2025/0139422 A1
(43) Pub. Date: May 1, 2025

(54) METHOD AND DEVICE WITH NEURAL NETWORK BIT-WIDTH QUANTIZATION TRAINING

(71) Applicant: Samsung Electronics Co., Ltd., Suwon-si (KR)

(72) Inventors: Shanshan LV, Xi’an (CN); Jonghoon YOON, Suwon-si (KR); Byung In YOO, Suwon-si (KR); Changyong SON, Suwon-si (KR); Sung-Jae CHO, Suwon-si (KR); Yunhao ZHANG, Xi’an (CN); Zhenxin YANG, Xi’an (CN); Miao ZHANG, Xi’an (CN)

(73) Assignee: Samsung Electronics Co., Ltd., Suwon-si (KR)

(21) Appl. No.: 18/919,294

(22) Filed: Oct. 17, 2024

(30) Foreign Application Priority Data
Nov. 1, 2023 (CN) 202311443379.9
Aug. 13, 2024 (KR) 10-2024-0108640

(51) Int. Cl. G06N 3/0495

(52) U.S. Cl. CPC G06N 3/0495

(57) ABSTRACT

A method performed by one or more processors includes: iteratively training layer-specific quantization levels and layer-specific quantization intervals of respective layers of a neural network of original weights by, for each training iteration, adjusting the quantization levels and quantization intervals to reduce a loss that is determined based on the original weights and is determined based on the original weights as quantized according to the quantization levels and quantization intervals at a current iteration of the training.

### CROSS-REFERENCE TO RELATED APPLICATIONS

This application claims the benefit under 35 USC § 119 (a) of Chinese Patent Application No. 202311443379.9 filed on Nov. 1, 2023, in the China National Intellectual Property Administration, and Korean Patent Application No. 10-2024-0108640, filed on Aug. 13, 2024, in the Korean Intellectual Property Office, the entire disclosures of which are incorporated herein by reference for all purposes.

### BACKGROUND

### 1. Field

The present disclosure relates to a neural network field, and more particularly, to a method and device with quantization bit-width training of a neural network.

### 2. Description of Related Art

Neural networks solve increasingly complex tasks in fields such as computer vision and natural language processing. A neural network may perform a complex task accurately, but large-scale neural networks may be difficult to deploy to edge devices, for example, which typically have limited computational ability and storage capacity.

Neural networks may be compressed to facilitate their deployment to edge devices. Compressed neural network models and perform inference speed faster than their uncompressed equivalents. In addition, compressed neural networks may be less complex and may require less resources to be stored.

Quantization is a conventional method of compressing a neural network. Quantization may involve converting parameters of the neural network (e.g., weight values) into a specific numeric format (e.g., a decimal point format) for which calculations (e.g., floating point calculations) have a relatively lower computational requirement. Compressing a neural network through quantization is currently the most widely used model compression method since the quantization is able to effectively reduce the neural network calculation intensity, total parameter size, and memory consumption.

However, conventional quantization schemes may be limited due to the use of a fixed (uniform) bit-width throughout a network model, which can make it difficult to satisfy demands for both accuracy and speed. That is to say, with conventional quantization techniques, a developer is often required to make a compromise between accuracy, speed, and memory/computation resource usage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of obtaining a quantized neural network is performed by a neural network quantization device, and the method includes: obtaining a target neural network in which weights of layers of the target neural network have been previously trained; until a loss is determined to converge, repeating: obtaining a temporary neural network having weights respectively corresponding to the weights of the target neural network; quantizing the weights of the temporary neural network according to a quantization level; determining the loss based on a difference between the weights of the target neural network and the quantized weights of the temporary neural network; updating the quantization level according to the loss; and obtaining the quantized neural network based on the temporary neural network after the loss has been determined to converge.

The target neural network may be obtained based on a result of training the weights of the target neural network before quantizing the weights of the target neural network based on the final updated quantization level after the loss has been determined to converge.

The weights of the target neural network may be weights of a convolutional layer or a fully-connected layer of the target neural network, the weights of each obtained temporary neural network may be the weights of the target neural network, and the method may further include setting the quantization level to an initial quantization level.

The quantizing the weights of the temporary neural network may include: transforming the weights of the temporary neural network based on a quantization interval; and the quantizing the weights of the temporary neural network according to the quantization level is performed on the transformed weights.

Layers of the temporary neural network may have respective layer-specific quantization intervals including the quantization interval, the layers of the temporary neural network may have respective layer-specific quantization levels including the quantization level, and the quantizing the weights of the temporary neural network may include: transforming the weights of each layer according to each layer's corresponding layer-specific quantization interval, and quantizing the transformed weights of each layer according to each layer's corresponding layer-specific quantization level.

The loss may be determined based on the transformed quantized weights of the temporary neural network.

The repeating may include updating the quantization interval together with the quantization level according to the loss.

The repeating may further include: quantizing an activation value output by a layer of the temporary neural network according to at least some of the quantized weights of the temporary neural network; and the loss may also be determined according to a difference between the quantized activation value of the temporary neural network and a corresponding activation value of the target neural network.

The determining of the loss may include: determining a first partial loss based on a temporary output obtained as a result of applying the quantized weights of the temporary neural network to a training input; determining a second partial loss based on a difference between a weight of the target neural network and a quantized weight of the temporary neural network or a difference between an activation value of the target neural network and a quantized activation value of the temporary neural network; and determining the loss based on the first partial loss and the second partial loss.

The quantization level may be a non-integer, and the obtaining of the quantized neural network may include: determining an integer number-format corresponding to the quantization level after the loss is determined to have converged; and obtaining the quantized neural network by quantizing the target neural network by a bit-width of the determined integer number-format.

The repeating: may obtain a first temporary neural network by quantizing at least a portion of the weights of the temporary neural network by rounding down when quantizing according to the quantization level; obtains a second temporary neural network by quantizing at least a portion of the weights of the temporary neural network by rounding up when quantizing according to the quantization level; and the updating the quantization level may be performed using a gradient descent method according to a difference between the quantized weights of the first temporary neural network and the quantized weights of the second temporary neural network.

The obtaining of the quantized neural network may include: tuning weights of the obtained quantized neural network using training data.

A non-transitory computer-readable storage medium may store instructions that, when executed by one or more processors, cause the one or more processors to perform any of the methods.

In another general aspect, a neural network quantization device includes one or more processors and a memory storing instructions configured to, when executed by the one or more processors, cause the one or more processors to perform a process including: obtaining a target neural network in which weights of layers of the target neural network have been previously trained; until a loss is determined to converge, repeating: obtaining a temporary neural network having weights respectively corresponding to the weights of the target neural network; quantizing the weights of the temporary neural network according to a quantization level; determining the loss based on a difference between the weights of the target neural network and the quantized weights of the temporary neural network; updating the quantization level according to the loss; and obtaining the quantized neural network based on the temporary neural network after the loss has been determined to converge.

The process may further include: transforming the weights of the temporary neural network based on a quantization interval, and quantizing the transformed weights according to the quantization level.

A quantization interval is specific to a layer of the temporary neural network and the quantization level may be specific to the layer of the temporary neural network, and the quantizing the weights of the temporary neural network may include transforming the weights of the layer according to the quantization interval and quantizing the transformed weights according to the quantization level.

The obtaining the temporary neural network may include copying weights of the target neural network to the temporary neural network.

The repeating may further include: quantizing activation values of the temporary neural network, determining the loss also according to a difference between the quantized activation values of the temporary neural network and corresponding activation values of the target neural network.

A first partial loss may be determined based on a temporary output obtained as a result of applying the temporary neural network to a training input, a second partial loss may be determined based on a difference between a weight of the target neural network and a quantized weight of the temporary neural network or a difference between an activation value of the target neural network and a quantized activation value of the temporary neural network, and the loss may be determined based on the first partial loss and the second partial loss.

In another general aspect, a method is performed by one or more processors, and the method includes: iteratively training layer-specific quantization levels and layer-specific quantization intervals of respective layers of a neural network of original weights by, for each training iteration, adjusting the quantization levels and the quantization intervals to reduce a loss that is determined based on the original weights and is determined based on the weights as quantized according to the quantization levels and quantization intervals at a current iteration of the training.

Other features and aspects will be apparent from the following detailed description, the drawings, and the claims.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates a quantization bit-width training method of a neural network, according to one or more embodiments;

FIG. 2 is illustrates an example configuration of a quantization bit-width training device for training a neural network, according to one or more embodiments; and

FIG. 3 illustrates an example of a method, performed by a neural network quantization device, of obtaining a quantized neural network, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Since the amount of information redundancy usually differs for each layer of a neural network, the demand for accuracy of quantization may be differ among layers. In other words, some layers may be more sensitive to quantization than others. For example, feature extraction through a shallow layer may require higher accuracy for overall performance, and a convolutional layer may require higher accuracy than a fully-connected layer. However, since it is difficult to manually set a quantization bit-width of each layer in a network, as described herein, the quantization bit-width (e.g., a quantization level) may be processed as a per-layer trainable parameter (or hyperparameter) and may be trained together with (e.g., simultaneously) training of a quantization interval (quantization bit-width refers to the number of bits of a quantized value, and a quantization interval refers to the range of possible values of −a quantization value). According to various embodiments of the present disclosure, an optimized net quantization effect of a neural network may be obtained by treating the quantization-bit width as a trainable parameter and training the same.

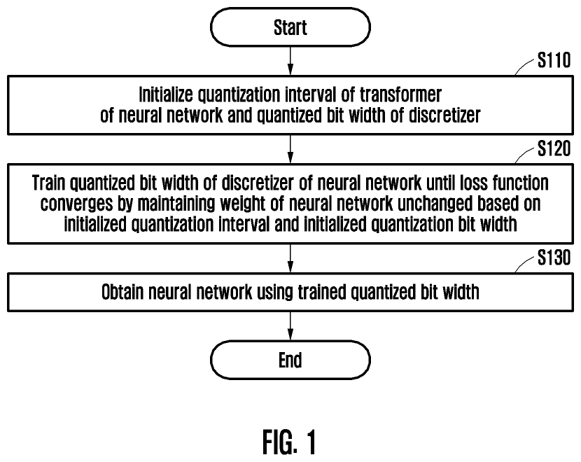

FIG. 1 illustrates a quantization bit-width training method of training a neural network, according to one or more embodiments.

As a non-limiting example, a neural network to be subjected to quantization training may include a convolutional layer and/or a fully-connected layer. For example, the neural network may be a deep residual network (e.g., an implementation of ResNet-50).

Referring to FIG. 1, in step S110, an electronic device may initialize both a quantization interval of a transformer of a neural network and a quantized bit-width of a discretizer. A convolutional layer and/or a fully-connected layer of the neural network may include a quantization module. In some cases, multiple layers may have their own respective quantization modules; description herein of a single quantization module may apply to each quantization module instance in such a case. The quantization module may include a transformer or a discretizer. The transformer may be used to map (transform) a weight and an activation value of the neural network to be within a quantization interval range (e.g., before discretization thereof). The discretizer may be used to discretize the mapped/transformed weight and activation value to a quantization bit-width. In various embodiments, a quantization interval used to transform a weight may be referred to as a weight quantization interval, and a quantization interval used to transform an activation value may be referred to as an activation quantization interval (the two intervals can differ). The quantization bit-width may also be referred to as a quantization level.

For example, the transformer may map a weight of the neural network to be within the quantization interval by executing processor-executable instructions configured according to Equation 1, and the transformer may map an activation value of the neural network to be within the quantization interval range by executing processor-executable instructions configured according Equation 2.

$$\hat{w} = \{ \begin{matrix}0 , & \vert w \vert < {c}_{W} - {d}_{W} \\ 1 , & \vert w \vert > {c}_{W} - {d}_{W} \\ {( {α}_{W} \vert w \vert + {β}_{w} )}^{γ} \cdot sign ( w ) , & otherwise\end{matrix} \qquad Equation 1$$

In this case, w denotes a weight before transformer processing, w may denotes a weight after transformer processing, c_{W} and d_{W} denote a quantization interval, sign denotes a sign function, and α_{W}, β_{W}, and γ denote predetermined constants. As a non-limiting example, α_{W} may be 0.5, β_{W} may be 0.5, and γ may be 1.

$$\hat{x} = \{ \begin{matrix}0 , & x < {c}_{X} - {d}_{X} \\ 1 , & x > {c}_{X} - {d}_{X} \\ {α}_{X} \times x + {β}_{X} & otherwise\end{matrix} \qquad Equation 2$$

In this case, x denotes an activation value before transformer processing, \hat{x} denotes an activation value after transformer processing, c_{X} and d_{X} denote a quantization interval, and α_{X} and β_{X} denote predetermined constants. As a non-limiting example, α_{X} may be 0.5 and β_{X} may be 0.5.

For example, the discretizer may discretize either a mapped weight or an activation value to a corresponding quantization bit-width (e.g., a quantization level n) by respective executions of processor-executable instructions configured according to Equation 3.

$$\overline{v} = \frac{round ( \hat{v} \cdot ( {2}^{n} - 1 ) )}{{2}^{n} - 1} \qquad Equation 3$$

In this case, \hat{ν} denotes a floating point number (e.g., ŵ of Equation 1 or \hat{x} of Equation 2), i denotes a floating point number after discretizer processing, n denotes a quantization bit-width (e.g., a quantization level), and round denotes a rounding function.

In step S110, the electronic device may initialize the quantization intervals and the quantization bit-widths {c_{W}_{ₗ}, d_{W}_{ₗ}, c_{X}_{ₗ}, d_{X}_{ₗ}, n_{W}_{ₗ}, n_{X}_{ₗ}}. In this case, c_{W}_{ₗ}, d_{W}_{ₗ}, c_{X}_{ₗ}, and d_{X}_{ₗ} are the same as c_{W}, d_{W}, c_{X}, and d_{X} of Equations 1 and 2, l denotes a specific layer of the neural network, n_{W}_{ₗ} denotes a quantization bit-width (e.g., a weight quantization level) specific to Wₗ, and n_{X}_{ₗ} denotes a quantization bit-width (e.g., an activation quantization level) specific to Xₗ. For example, the electronic device may initialize c_{W}_{ₗ}, d_{W}_{ₗ}, c_{X}_{ₗ}, and d_{X}_{ₗ} to 0.5 and may initialize n_{W}_{ₗ} and n_{X}_{ₗ} to 3.5. However, the quantization interval and/or the quantization bit-widths are not necessarily initialized to the values described above, and may vary depending on the design. In network training, the quantization bit-width may be the bit-width of a floating point number (e.g. a number of FP bits), for example (see Equation 8 below for additional understanding of a bit-width of a floating point number format).

In step S120, based on the initialized quantization intervals and the initialized quantization bit-widths, the electronic device may train the quantization bit-widths of the discretizers of the neural network until a loss function converges, and during the training the weights of the neural network may be maintained (not changed). In this case, the loss function may indicate a distribution distance between (i) weights and activation values of a neural network in which a quantization module is not included and (ii) corresponding weights and activation values of a corresponding neural network in which a quantization module is included.

For example, the electronic device may determine the loss function by executing processor-executable instructions configured according to Equation 4, for example.

$${loss}_{quantizer} = \frac{1}{μ} {\sum }_{i = 1}^{l} ( {\sum }_{k} ( P ( {v}_{i} ) log ( P ( {v}_{i} ) ) - P ( {\overline{v}}_{i} ) log ( P ( {\overline{v}}_{i} ) ) ) ) + \frac{1}{ξ} {\sum }_{i}^{l} {n}_{i}^{2} \qquad Equation 4$$

In this case, loss_{quantizer} denotes the loss function, l denotes a specific layer of the neural network, νᵢ denotes a log softmax distribution of a weight or an activation value (as the case may be) of a neural network excluding (not using) the quantization module, ν̅ denotes a log softmax distribution of a weight or an activation value of a neural network including the quantization module (e.g., ν̅ denotes a log softmax distribution of ν̅ obtained with code implementing Equations 1, 2, and/or 3), P(ν) denotes a probability distribution of ν, nᵢ denotes a quantization bit-width of a neural network layer i, and μ and ξ denote predetermined constants. For example, μ may be 100, and/or ξ may be 100.

For example, the electronic device may determine the loss function by executing processor-executable instructions configured according to Equation 5.

$$Loss = {Loss}_{classification} + \frac{1}{θ} \times {loss}_{quantizer} \qquad Equation 5$$

In this case, Loss_{classification} denotes a predetermined loss function of the neural network, and θ denotes a predetermined constant. For example, θ may be 20.

In various embodiments of the present disclosure, the loss function based on Equations 4 and 5 is provided. However, the loss function is not limited to being based on Equation 4 and/or Equation 5, and the electronic device may use another loss function.

According to an embodiment, the electronic device may train the quantization bit-widths of the respective discretizers of the neural network by updating the quantization bit-widths of the discretizers of the neural network using a gradient descent method.

Specifically, in the case of a gradient backpropagation process, each discretizer may include a round function (e.g., a rounding function) that is discrete and is unable to directly calculate the gradient. Accordingly, linear interpolation may be used to estimate differentiation. For example, training n according to the gradient descent method may include updating n by executing code configured according to Equation 6.

$$n ← n - \frac{\partial \overline{{v}_{n} ( \hat{v} )}}{\partial n} \overline{{v}_{n} ( \hat{v} )} \approx \overline{{v}_{⌊ n ⌋} ( \hat{v} )} + η \overline{( {v}_{⌈ n ⌉} ( \hat{v} )} - \overline{{v}_{⌊ n ⌋} ( \hat{v} )} ) η = ( n - ⌊ n ⌋ ) / ( ⌈ n ⌉ - ⌊ n ⌋ ) \qquad Equation 6$$

In this case, [n] denotes rounding down n (floor), [n] denotes rounding up n (ceiling), and \overline{νₙ(\hat{ν})} denotes a result of discretization processing of \hat{ν} according to Equation 3.

Based on Equation 6, Equation 7 may be obtained.

$$\frac{\partial \overline{{v}_{n} ( \hat{v} )}}{\partial n} = \overline{( {v}_{⌈ n ⌉} ( \hat{v} )} - \overline{{v}_{⌊ n ⌋} ( \hat{v} )} ) * \frac{1}{τ} \qquad Equation 7$$

In this case, t may be a predetermined constant. For example, t may be 1,000.

In some embodiments, the electronic device may train quantization intervals of the respective transformers of the neural network while training the quantization bit-widths of the discretizers of the neural network. In other words, the quantization bit-width of a discretizer of the neural network and the quantization interval of the transformer of the neural network may be simultaneously trained. However, the example is not limited thereto, and the method of training the quantization bit-width of a discretizer of the neural network and training the quantization interval of the transformer of the neural network may be variously changed (e.g., they may be trained separately).

In step S130, the electronic device may obtain/configure a neural network that uses the trained quantization bit-widths.

In this case, since each updated parameter is, for example, a floating point number type, maintaining an integer quantization bit-width may be impossible. Simultaneously, the electronic device may integerize the quantization bit-width of the floating point number to match the hardware as closely as possible, after the training is completed. For example, the electronic device may integerize the trained quantization bit-widths. The electronic device may apply the integerized quantization bit-widths to the neural network.

For example, the electronic device may integerize the quantization bit-widths by executing processor-executable code configured according to Equation 8 shown below.

$${n}_{i n t} = \{ \begin{matrix}4 , & {n}_{float} < 6 \\ 8 , & 6 < {n}_{float} < 12 \\ 16 , & 12 < {n}_{float} < 24 \\ 32 , & {n}_{float} > 24\end{matrix} \qquad Equation 8$$

In this case, nᵢₙₜ denotes an integerized quantization bit-width (e.g., a number of integer bits), and n_{float} denotes a pre-integerized quantization bit-width (e.g., a number of bits) of a floating point number.

The electronic device may, separately from the quantization training, perform training on weights of the neural network that uses the trained quantization bit-width for fine-tuning to guarantee/preserve accuracy using the integerized quantization bit-widths.

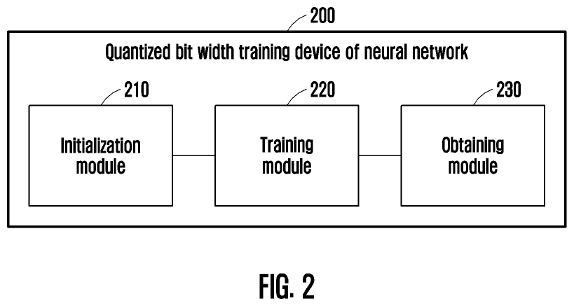

FIG. 2 illustrates an example configuration of a quantization bit-width training device for training a neural network, according to one or more embodiments.

Referring to FIG. 2, a quantization bit-width training device 200 for training a neural network may include an initialization module 210, a training module 220, and an obtaining module 230.

The initialization module 210 may be configured to initialize quantization intervals of respective transformers of the neural network and quantization bit-widths of respective discretizers. For example, each layer of the neural network may have a respective pair of a quantization bit-width and a quantization interval, and the initialization module 210 may initialize the quantization bit-width and quantization interval of each respective layer to an initial value (e.g., a same default value used for each layer, or a predetermined value suited to the network or task at hand). For example, a convolutional layer and/or a fully-connected layer of the neural network may each include a respective quantization module. Each quantization module may include a transformer and/or a discretizer. To summarize, each layer (or some layers) of the neural network may have its own respective quantization module, each of which may include its own quantization bit-width and its own quantization interval which are specific to the quantization module's layer. In practice, a quantization module may include only those pieces of information, and the operations (and possibly the executable code or instances thereof) of each of the quantization modules may be the same. However, in some cases it is possible that quantization modules of different layers may execute different quantization logic.

The training module 220 may be configured to train the quantization bit-widths of the discretizers of the neural network until the loss function converges while not-changing (maintaining) the weights of the neural network, based on the initialized quantization intervals and the initialized quantization bit-widths. The loss function may indicate a distribution of distances between (i) weights and activation values of a neural network in which a quantization module is not included/used and (ii) corresponding weights and activation values of a neural network in which a quantization module is included/used.

The training module 220 may be configured to perform training by updating the quantization bit-widths of the respective discretizers of the neural network using the gradient descent method. The training module 220 according to an embodiment may be configured to train the quantization bit-widths of the respective discretizers of the neural network while simultaneously training the quantization intervals of the respective transformers of the neural network.

The obtaining module 230 may be configured to obtain/generate a neural network that uses the trained quantization bit-widths. To that end, the obtaining module 230 may integerize the trained quantization bit-widths. The obtaining module 230 may then apply the integerized quantization bit-widths to the neural network. In other words, when the bit-widths are finally trained (after loss convergence), the bit-widths may be integerized, that is, changed from one format (e.g., with a first number of bits) to another integer format (e.g., with a second number of bits).

The quantization bit-width training device 200 of the neural network according to an embodiment may further include a fine-tuning module (not shown) configured to perform fine-tuning by training weights of the neural network that uses the trained quantization bit-width.

Other operations corresponding to the initialization module 210, the training module 220, the obtaining module 230, and the fine-tuning module are the same as or similar to the quantization bit-width training method described above with reference to FIG. 1.

A method of training quantization bit-widths of a neural network is described next. The method may include initializing quantization intervals of respective transformers of the neural network and initializing quantization bit-widths of respective discretizers; as noted above, each convolutional layer and/or fully-connected layer of the neural network may include a respective quantization module that has its own transformer and the discretizer. The method may also include training the quantization bit-width of the discretizer of the neural network until a loss function converges and maintaining a weight of the neural network (not changing the weight during the quantization training), where the training is based on the initialized quantization interval and the initialized quantization bit-width. The loss function may indicate a distribution of distances between (i) weights and activations of a neural network in which a quantization module is not included and (ii) corresponding weight and activations of a neural network in which a quantization module is included, and the distribution of distances may be used to obtain a neural network that uses the quantization bit-width(s) and/or interval distance(s) trained independently from the weight(s), for example of the obtained neural network.

The training of the quantization bit-widths of the respective discretizers of the neural network may include performing training by updating the quantization bit-widths of the discretizers of the neural network using a gradient descent method.

While training the quantization bit-widths of the discretizers of the neural network, the quantization intervals of the respective transformers of the neural network may also be trained.

The obtaining of the neural network that uses the trained quantization bit-widths may include integerizing (e.g., converting to integer from various forms such as floating-point (FP) or fixed point) the trained quantization bit-widths and applying the integerized bit-widths to the neural network.

The above method for learning the quantization bit-widths of a neural network may further include a step of performing fine-tuning by training the weights of the neural network using the trained quantization bit-widths.

As described herein, in some embodiments, a quantization bit-width training device of a neural network may be generated, and the device may include an initialization module that initializes the quantization intervals of respective transformers of the neural network and initializes a quantization bit-widths of respective discretizers. Convolutional layer(s) and/or fully-connected layer(s) of the neural network may include respective quantization modules, and each quantization module may include its own transformer and the discretizer. A training module may be configured to train the quantization bit-widths of the discretizers until a loss function converges by maintaining, during training, weights of the neural network, and the training may be based on initialized quantization intervals and the initialized quantization bit-widths, where the loss function indicates a distribution distance between (i) weights and activations of a neural network in which a quantization module is not included/used and (ii) corresponding weights and activations of a neural network in which a quantization module is included/used. An obtaining module may be configured to obtain a neural network that uses the trained quantization bit-widths. As used herein, depending on context, “weight”, “bit-width”, “activation value”, and “quantization interval” can refer to an individual connection weight/width/interval/activation or it can refer to the set of connection weights/widths/intervals/activations of a neural network. When such a term refers to the singular, it will be understood that the singular description also applies to the multiple.

The training module may be further configured to perform training by updating the quantization bit-widths of the respective discretizers of the neural network using a gradient descent method.

The training module may be further configured to train the quantization intervals of the respective transformers of the neural network while training the quantization bit-width of the discretizer of the neural network.

The obtaining module may be further configured to integerize the trained quantization bit-widths and apply the integerized quantization bit-widths to the neural network.

The quantization bit-width training device of the neural network may further include a fine-tuning module configured to perform fine-tuning by training weights of a neural network that uses the trained quantization bit-widths.

An electronic device may be configured to perform the disclosed methods and components. The electronic device may include a memory and a processor, the memory may store computer-executable instructions, and the instructions may perform/execute the methods/components when executed by the processor.

A computer-readable storage medium may be configured to store computer-executable instructions to perform/execute the methods/components when executed.

Various of the embodiments and examples described herein may improve post-quantization network accuracy by training quantization bit-widths of a neural network, moreover, the sizes of a model's parameters (e.g., weights) may be reduced, and an optimal quantization effect may be achieved by improving the inference speed while reducing the footprint (resource requirements) of the neural network. The training of the quantization bit-widths may be induced according to a distance of pre-quantization and post-quantization distributions of the neural network, and, since the training of the quantization bit-widths may be induced by training quantization intervals, there may be no need to waste time on a search since a loss function easily and rapidly converges. In addition, the quantization bit-width training methods and devices as described herein may be used for neural network model deployment to improve the inference speed of a neural network model in a hardware device and may decrease the size of the neural network model to facilitate deployment in devices with limited resources. For example, the quantization bit-width training methods and devices may be applied to neural network model deployment of a client on a device, such as a portable mobile device or an Internet of Things (IoT) device, to increase the model inference speed and improve user experience.

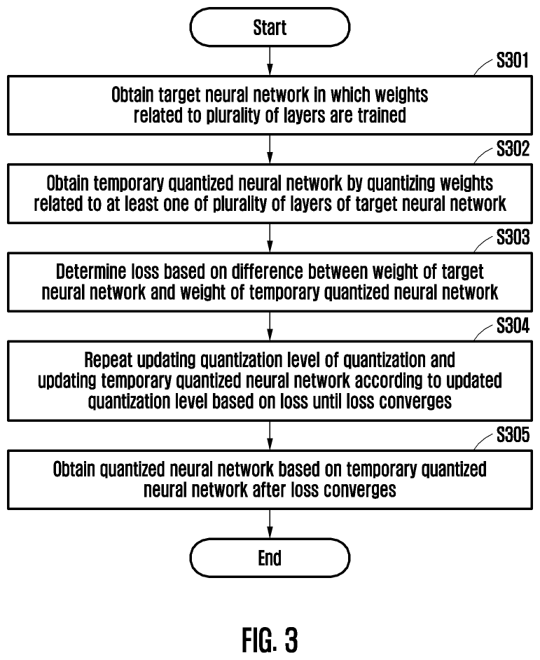

FIG. 3 illustrates an example of a method, performed by a neural network quantization device, of obtaining a quantized neural network, according to one or more embodiments.

The neural network quantization device (e.g., the quantized bit-width training device 200 of the neural network of FIG. 2) may obtain, from a trained target neural network, a quantized neural network having been quantized for a weight and/or an activation value of the target neural network.

The neural network quantization device may include at least one processor (i.e., one or more processors) and a memory. The at least one processor may include a processing circuit. The memory may include one or more storage media, and the one or more storage media may store instructions. The instructions, when collectively and/or individually executed by the at least one processor, may cause the neural network quantization device to perform an operation. Example operations of the neural network quantization device are described next.

In step S301, the neural network quantization device may obtain a target neural network in which weights related to layers have been pre-trained (e.g., for a task such as object recognition). The target neural network may include the layers. Each layer may include an operation that applies, to an input, a weight of the layer. The operations of the layers of the target neural network may applied to a training input to iteratively update weights of the target neural network such that the target neural network approaches outputting a specific value (e.g., a ground truth value). In this pre-training of the weights of the target neural network, training quantization for the weights and/or the activations value may be excluded (e.g., performed in a separate training procedure or step). In some implementations, all quantization training may be performed first, followed by parameter (e.g., weight/activation) training. In other implementations, quantization and parameter training may be interleaved, e.g., a quantization-only training pass (or passes) may be followed by a parameter-only training pass (or passes). Interleaved training may also be performed at the layer level. For example, quantization training may be completed for one layer and then weight training may be performed that layer, and the same process may proceed to another layer. Or, quantization training may be partly performed at one layer, weight training may then be partly performed for that layer, for each of the layers, to perform a single training pass, and multiple passes may be performed until overall training is completed.

To summarize step S301, the neural network quantization device may obtain/configure the target neural network by updating the weights of the target neural network. For example, the neural network quantization device may obtain the target neural network based on a result of training the weights of the layers of the target neural network while excluding (or prior to) any quantization-related training for the target neural network. As described above, the split-training approach can be performed in a variety of ways to complete the overall training process.

In step S302, the neural network quantization device may obtain a temporary (i.e., in-progress or intermediate) quantized neural network by quantizing weights related to at least one of the layers of the target neural network (conceptually, the temporary quantized neural network may be thought of as a copy (or partial copy) of the target neural network). The temporary quantized neural network may have the same or similar structure to the structure (e.g., the same number of layers, the same number of nodes, and the same connections between the nodes, and initially, the same weights) of the target neural network, and may represent, after various operations described next, a result of applying quantization to the weights and/or the activation values of the target neural network.

For example, the layers of the target neural network may include convolutional layer(s) and/or a fully-connected layer(s). The neural network quantization device may obtain the temporary quantized neural network by quantizing, at an initial quantization level, weights related to at least one layer of the convolutional layer and the fully-connected layer among the layers. In some embodiments described herein, the quantization level of the temporary quantized neural network may be a floating point number or other non-integer types. The quantizing may be performed for multiple or all layers of the temporary neural network.

Examples of the quantization may include transformation and discretization. For example, to obtain/update the temporary quantized neural network, the neural network quantization device may transform the weights related to the at least one layer based on the layer's quantization interval and may quantize the transformed weights at the layer's quantization level (e.g., quantization bit-width). The transformation of the weights may be performed based on Equation 1. In Equation 1, w denotes a specific weight (e.g., a weight before transformation) of the target neural network, ŵ denotes a transformed weight of the specific weight w of the target neural network, and c_{W} and d_{W} denote a quantization interval (also referred to herein as a “weight quantization interval”) for transforming a weight.

The quantization of a weight at a quantization level may be performed based on Equation 3. In Equation 3, letting \hat{ν} represent the transformed weight ŵ (i.e., substituting ŵ in for \hat{ν}), the result ν̅ then denotes a discretized weight (i.e., w̅) of the transformed weight ŵ, and n denotes a quantization level used for the discretization. In this case, the transformed weight ŵ or \hat{ν} and/or the discretized weight ν̅ or w̅ may be floating point numbers (or other non-integers).

The neural network quantization device may, as per training described above, obtain independent (layer-specific) quantization interval and an independent quantization level for each layer of the temporary quantized neural network. For each layer, the neural network quantization device may transform and quantize weights thereof using the quantization interval corresponding to (specific to) the layer and by using the quantization level corresponding to (specific to) the layer. For example, the weights of the layers may be quantized using a different weight quantization interval and a different quantization level for each layer. Put another way, weights of a first layer of the temporary network may be quantized using a first weight quantization interval and a first quantization level associated with the first layer, and weights of a second layer of the temporary network may be quantized using a second weight quantization interval and a second quantization level associated with the second layer. As described below in step S304, the weight quantization interval(s) may be updated (e.g., trained) based on a loss.

Although various embodiments and examples are mainly described herein as having the neural network quantization device quantize weights of a target neural network, other approaches may be used. For example, the neural network quantization device may obtain a temporary quantized neural network by adding a quantization operation for at least a portion of activation values of the target neural network.

In one or more embodiments, the neural network quantization device may add, to at least one of the layers of the target neural network, a quantization operation for quantizing an activation value outputted by at least one layer. Adding, to a neural network, a quantization operation for activation values output by a specific layer may also be referred to as “quantizing the activation values of the specific layer”. The quantization operation for the activation values may include transformation and discretization of the activation values, similar to the quantization operation used for quantizing the weights.

For example, to obtain the temporary quantized neural network, the neural network quantization device may add, to the target neural network, an operation that transforms the activation values output by at least one of the layers and quantizing the transformed activation values at (or according to) the quantization level. The same may be performed for several or each of the target neural network's layers.

The added operation of transformation of the activation value(s) may be performed with code based on Equation 2. In Equation 2, x denotes a specific activation value (e.g., an activation value before transformation) of the target neural network, \hat{x} denotes a transformed activation value of the specific activation value x of the target neural network, and c_{X} and d_{X} denote a corresponding quantization interval (also referred to herein as an “activation quantization interval”) for transformation of the activation value. The quantization interval (e.g., c_{X} and/or d_{X}) for transformation of the activation value may be obtained or updated separately (e.g., in a different value) from the obtaining/updating of a quantization interval (e.g., c_{W} and/or d_{W}) for transformation of a weight.

An activation quantization interval may be independently determined for each layer, in a manner similar to how weight quantization intervals are determined. Each layer may have its own independent activation quantization interval. For example, the neural network quantization device may add an operation to (or activate an operation in) the target neural network, where the operation quantizes sets of activation values outputted by respective layers using different (e.g., layer-specific) activation quantization intervals of the respective layers. The neural network quantization device may add a first operation to (or activate a first operation in) the target neural network that quantizes first activation values output by a first layer using a first activation quantization interval and may add a second operation to (or activate a second operation in) the target neural network that quantizes second activation values output by a second layer using a second weight quantization interval. As described later with reference to step S304, an activation quantization interval may be updated (e.g., trained) based on a loss computed therefrom (and possibly based also on other information, as described above).

The discretization of a transformed activation value (e.g., transformed per a quantization interval) of the target neural network is described based on Equation 3. In Equation 3, letting \hat{ν} represent a transformed activation value \hat{x} (i.e., substituting \hat{x} in for \hat{ν}), ν̅ denotes an activation value of the transformed activation value \hat{x} discretized as per the quantization level n. In this case, the transformed activation value \hat{x} or \hat{ν} and/or the discretized activation value ν̅ (i.e., x̅) may be floating point numbers (or other types of non-integers).

In an embodiment, the quantization level used for quantizing the weight(s) of a specific layer may be the same as the quantization level used for quantizing an activation value output by the specific layer. In another embodiment, they may differ.

In step S303, the neural network quantization device may determine a loss based on a difference between the weight of the target neural network and the weight of the temporary quantized neural network. The neural network quantization device may determine at least a portion of the loss based on Equation 4.

In Equation 4, loss_{quantizer} denotes at least a portion (e.g., a quantization loss) of the loss, l denotes the number of layers in which a weight (or an activation value) is quantized among the temporary quantized neural network, i denotes a specific layer in which a weight (or an activation value) is quantized among the temporary quantized neural network, νᵢ denotes a weight (or an activation value, as the case may be) of a layer i of the target neural network, ν̅ᵢ denotes a weight (or a quantized activation value) (e.g., ν̅ of Equation 3) of a layer i of the temporary quantized neural network, P (vi) denotes a probability distribution of νᵢ, P(ν̅ᵢ) denotes a probability distribution of ν̅ᵢ, P(νᵢ) log (P(νᵢ)) denotes a log softmax distribution of νᵢ, P(ν̅ᵢ) log (P(ν̅ᵢ)) denotes a log softmax distribution of ν̅ᵢ, and nᵢ denotes a quantization level corresponding to a layer i of the temporary quantized neural network.

The neural network quantization device may use a result of applying the target neural network to a training input and a result of applying the temporary quantized neural network to the training input to determine a quantization loss related to the activation value. For example, the neural network quantization device may apply an added quantization operation while applying the temporary quantized neural network to the training input. The neural network quantization device may determine a loss (e.g., the quantization loss loss_{quantizer}) based on the difference between the activation value νᵢ of the target neural network and the quantized activation value ν̅ᵢ of the temporary quantized neural network.

However, the neural network quantization device according to various embodiments of the present disclosure is not limited to determining the loss to be the quantization loss. For example, the neural network quantization device may determine the loss based on a first partial loss related to the accuracy of an output of the temporary quantized neural network and a second partial loss (e.g., the quantization loss) related to quantization of the activation value. The first partial loss may be determined based on a temporary output obtained by applying the temporary quantized neural network to the training input. For example, the first partial loss may be determined based on the difference between a temporary output and ground truth. As described above, the second partial loss may be determined based on at least one of the difference between the weight of the target neural network and the weight of the temporary quantized neural network or the difference between the activation value of the target neural network and the weight value of the temporary quantized neural network.

For example, the neural network quantization device may determine the loss based on Equation 5. In Equation 5, Loss denotes a loss, Loss_{classification} denotes the first partial loss, and loss_{quantizer} denotes the second partial loss.

In step S304, the neural network quantization device may repeat updating the quantization level of the quantization and updating the temporary quantized neural network according to the updated quantization level until the loss converges. In some embodiments, at each repetition of updating the temporary quantized neural network, the quantization parameters thereof are updated/trained, but the original weight values (weight values from the target neural network) are used (i.e., the weights are maintained, aside from their temporary quantization as used to determine the loss at an iteration).

According to an embodiment, the neural network quantization device may repeat updating the quantization intervals (e.g., the weight quantization intervals and the activation quantization intervals) based on the loss until the loss converges. Each quantization interval may be expressed as a pair of parameters (e.g., c_{X} and d_{X} of the activation quantization interval and c_{W} and d_{W} of the weight quantization interval), and the neural network quantization device may update each parameter based on the loss. The neural network quantization device may update the quantization interval (e.g., the weight quantization interval and the activation quantization interval) together with (e.g., simultaneously) the quantization level, based on the temporary quantized neural network.

According to an embodiment, the neural network quantization device may update the quantization level using at least one temporary neural network. The update of the quantization level may be performed according to at least one temporary neural network independently of the loss.

The neural network quantization device may obtain a first temporary neural network by quantizing at least a portion of the target neural network by a first bit-width obtained by applying rounding down to the quantization level. The neural network quantization device may obtain a second temporary neural network by quantizing at least a portion of the target neural network by a second bit-width obtained by rounding up to the quantization level. The neural network quantization device may update the quantization level using the gradient descent method for a difference between a weight of the first temporary neural network and a weight of the second temporary neural network. However, the neural network quantization device according to various embodiments of the present disclosure is not limited to updating the quantization level based on the difference between weights. For example, the neural network quantization device may update the quantization level using the gradient descent method for a difference between a quantized activation value of the first temporary neural network and a quantized activation value of the second temporary neural network.

For example, updating the quantization level by the neural network quantization device may be performed based on Equation 6 and/or Equation 7. In Equation 6, n denotes a quantization level, [n] denotes an integer (e.g., the first bit-width) obtained by applying rounding down to the quantization level n, [n] denotes an integer (e.g., the second bit-width) obtained by applying rounding up to the quantization level n, \overline{νₙ(\hat{ν})} denotes a weight or an activation value quantized at the quantization level n, \overline{ν_{[n]}(\hat{ν})} denotes a weight or an activation value of the first temporary neural network quantized by the first bit-width [n], and \overline{(ν_{[n]}(\hat{ν})} denotes a weight or an activation value of the second temporary neural network quantized by the second bit-width [n].

In step S305, the neural network quantization device may obtain a quantized neural network based on the temporary quantized neural network after the loss has converged.

For example, the neural network quantization device may determine an integer corresponding to the quantization level after the loss has converged. As described above, the quantization level of the temporary quantized neural network may be a non-integer. The neural network quantization device may determine an integer of the quantization level based on Equation 8. In Equation 8, n_{float} denotes a quantization level of the temporary quantized neural network, and nᵢₙₜ denotes an integer (e.g., the bit-width) corresponding to the quantization level. The neural network device may then use the bit-width of the determined integer to obtain the quantized neural network by quantizing the target neural network with the determined integer.

Although not explicitly illustrated in FIG. 3, the neural network quantization device may fine-tune weights of the quantized neural network obtained using training data (e.g., the pre-trained (or target) neural network after its weights have been quantized with the learned quantization parameters). The neural network quantization device may update (e.g., train) the weights of the quantized neural network through fine-tuning.

An electronic device may be provided, and the electronic device may include a memory and a processor, the memory may store computer-executable instructions, and the instructions may perform the method when executed by the processor.

A computer-readable storage medium configured to store instructions may be further provided, and when the instructions are executed by at least one processor, the instructions may cause the at least one processor to perform a quantization bit-width training method of a neural network according to an embodiment of the present disclosure. Examples of a non-transitory computer-readable storage medium may include read-only memory (ROM), random access programmable read-only memory (PROM), electrically erasable programmable read-only memory (EEPROM), random-access memory (RAM), dynamic RAM (DRAM), static RAM (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, a hard disk drive (HDD), a solid state drive (SSD), card memory (e.g., a multimedia card, a secure digital (SD) card, or an extreme digital (XD) card), magnetic tapes, floppy disks, magneto-optical data storage devices, optical data storage devices, hard disks, solid-state disks, and any other device. The any other device may store computer programs and any associated data, data files, and data structures in a non-transitory manner and provide the computer programs and any associated data, data files, and data structures to a processor or computer so that the processor or computer may execute the computer programs. The instructions or computer programs in the non-transitory computer-readable storage medium may run in an environment deployed in a computer device such as a client, a host, a proxy device, a server, and the like. In an example, the computer programs and any associated data, data files and data structures may be distributed over network-coupled computer systems so that the computer programs and any associated data, data files, and data structures may be stored, accessed, and executed in a distributed fashion by one or more processors or computers.

By adopting embodiments and examples described herein, improved quantization accuracy may be achieved by training quantization bit-widths of a quantization module of a neural network, the sizes of model parameters may be reduced, and an optimized quantization effect may be achieved by improving the inference speed. The training of the quantization bit-widths may be induced according to a distance of pre and post quantization distributions of the neural network, and since the training of the quantization bit-widths may be induced by training quantization intervals, time for a search may be avoided since a loss function easily and rapidly converges. In addition, the quantization bit-width training methods and devices may be used for neural network model deployment to improve the inference speed of a neural network model in a hardware device and may decrease the size of the neural network model to easily deploy the neural network model in devices with limited resources. For example, the quantization bit-width training methods and devices may be applied to neural network model deployment of a client on a device, such as a portable mobile device or an IoT device, to increase the model inference speed and improve user experience. It will also be appreciated that electronic/computing devices may use neural networks may perform various tasks with respect to their own operations. For example, neural networks may be used to infer memory management decisions, allocate resources, prioritize threads, and the like. Therefore, the improvements in neural network efficiency described herein can necessarily be used to improve the general computation efficiency of those electronic/computing devices in and of themselves. Moreover, referring to the examples described above of convolutional neural networks paired with fully connected layers, it will be apparent that the improved quantization of such neural networks necessarily involves the improved efficiency of such types of neural networks, for example, for use in object recognition/detection in images, or any of the other known applications for such types of neural networks.

The electronic devices mentioned herein may be any of various types of electronic devices. The electronic devices may include, for example, a portable communication device (e.g., a smartphone), a computer device, a portable multimedia device, a portable medical device, a camera, a wearable device, or a home appliance device, as non-limiting examples.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The computing apparatuses, the electronic devices, the processors, the memories, the image sensors, the vehicle/operation function hardware, the ADAS/AD systems, the displays, the information output system and hardware, the storage devices, and other apparatuses, devices, units, modules, and components described herein with respect to FIGS. 1-3 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-3 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method, performed by a neural network quantization device, of obtaining a quantized neural network, the method comprising:
obtaining a target neural network in which weights of layers of the target neural network have been previously trained;
until a loss is determined to converge, repeating:
obtaining a temporary neural network having weights respectively corresponding to the weights of the target neural network;
quantizing the weights of the temporary neural network according to a quantization level;
determining the loss based on a difference between the weights of the target neural network and the quantized weights of the temporary neural network;
updating the quantization level according to the loss; and
obtaining the quantized neural network based on the temporary neural network after the loss has been determined to converge.

2. The method of claim 1, wherein the target neural network is obtained based on a result of training the weights of the target neural network before quantizing the weights of the target neural network based on the final updated quantization level after the loss has been determined to converge.

3. The method of claim 1, wherein the weights of the target neural network are weights of a convolutional layer or a fully-connected layer of the target neural network, wherein the weights of each of obtained temporary neural network are the weights of the target neural network, and wherein the method further comprises setting the quantization level to an initial quantization level.

4. The method of claim 1, wherein the quantizing the weights of the temporary neural network comprises:
transforming the weights of the temporary neural network based on a quantization interval; and
the quantizing the weights of the temporary neural network according to the quantization level is performed on the transformed weights.

5. The method of claim 4, wherein layers of the temporary neural network have respective layer-specific quantization intervals including the quantization interval, wherein the layers of the temporary neural network have respective layer-specific quantization levels including the quantization level, and wherein the quantizing the weights of the temporary neural network comprises:
transforming the weights of each layer according to each layer's corresponding layer-specific quantization interval, and
quantizing the transformed weights of each layer according to each layer's corresponding layer-specific quantization level.

6. The method of claim 4, wherein the loss is determined based on the transformed quantized weights of the temporary neural network.

7. The method of claim 6, wherein the repeating comprises updating the quantization interval together with the quantization level according to the loss.

8. The method of claim 1, wherein the repeating further comprises quantizing an activation value output by a layer of the temporary neural network according to at least some of the quantized weights of the temporary neural network; and wherein the loss is also determined according to a difference between the quantized activation value of the temporary neural network and a corresponding activation value of the target neural network.

9. The method of claim 8, wherein the determining of the loss comprises:
determining a first partial loss based on a temporary output obtained as a result of applying the quantized weights of the temporary neural network to a training input;
determining a second partial loss based on a difference between a weight of the target neural network and a quantized weight of the temporary neural network or a difference between an activation value of the target neural network and a quantized activation value of the temporary neural network; and
determining the loss based on the first partial loss and the second partial loss.

10. The method of claim 1, wherein the quantization level is a non-integer, and the obtaining of the quantized neural network comprises:
determining an integer number-format corresponding to the quantization level after the loss is determined to have converged; and
obtaining the quantized neural network by quantizing the target neural network by a bit-width of the determined integer number-format.

11. The method of claim 1, wherein the repeating:
obtains a first temporary neural network by quantizing at least a portion of the weights of the temporary neural network by rounding down when quantizing according to the quantization level;
obtains a second temporary neural network by quantizing at least a portion of the weights of the temporary neural network by rounding up when quantizing according to the quantization level;
and wherein the updating the quantization level is performed using a gradient descent method according to a difference between the quantized weights of the first temporary neural network and the quantized weights of the second temporary neural network.

12. The method of claim 1, wherein the obtaining of the quantized neural network comprises:
tuning weights of the obtained quantized neural network using training data.

13. A non-transitory computer-readable storage medium storing instructions that, when executed by one or more processors, cause the one or more processors to perform the method of claim 1.

14. A neural network quantization device comprising:
one or more processors; and
a memory storing instructions configured to, when executed by the one or more processors, cause the one or more processors to perform a process comprising:
obtaining a target neural network in which weights of layers of the target neural network have been previously trained;
until a loss is determined to converge, repeating:
obtaining a temporary neural network having weights respectively corresponding to the weights of the target neural network;
quantizing the weights of the temporary neural network according to a quantization level;
determining the loss based on a difference between the weights of the target neural network and the quantized weights of the temporary neural network;
updating the quantization level according to the loss; and
obtaining the quantized neural network based on the temporary neural network after the loss has been determined to converge.

15. The neural network quantization device of claim 14, wherein the process further comprises:
transforming the weights of the temporary neural network based on a quantization interval, and
quantizing the transformed weights according to the quantization level.

16. The neural network quantization device of claim 15, wherein a quantization interval is specific to a layer of the temporary neural network and the quantization level is specific to the layer of the temporary neural network, and
the quantizing the weights of the temporary neural network comprises transforming the weights of the layer according to the quantization interval and quantizing the transformed weights according to the quantization level.

17. The neural network quantization device of claim 15, wherein the obtaining the temporary neural network comprises copying weights of the target neural network to the temporary neural network.

18. The neural network quantization device of claim 14, wherein the repeating further comprises:
quantizing activation values of the temporary neural network,
determining the loss also according to a difference between the quantized activation values of the temporary neural network and corresponding activation values of the target neural network.

19. The neural network quantization device of claim 18, wherein:
a first partial loss is determined based on a temporary output obtained as a result of applying the temporary neural network to a training input,
a second partial loss is determined based on a difference between a weight of the target neural network and a quantized weight of the temporary neural network or a difference between an activation value of the target neural network and a quantized activation value of the temporary neural network, and
the loss is determined based on the first partial loss and the second partial loss.

20. A method performed by one or more processors, the method comprising: iteratively training layer-specific quantization levels and layer-specific quantization intervals of respective layers of a neural network of original weights by, for each training iteration, adjusting the quantization levels and quantization intervals to reduce a loss that is determined based on the original weights and is determined based on the original weights as quantized according to the quantization levels and quantization intervals at a current iteration of the training.
